(19) United States
(12) Patent Application Publication
(10) Pub. No.: US 2007/0055666 A1
(43) Pub. Date: Mar. 8, 2007

(54) Personalisation

(75) Inventors: Richard Eric Newbould, Ipswich (GB); Colin Peter Markwell, Ipswich (GB); Robert John Collingridge, Ipswich (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS PUBLIC LTD CO., Greator London (GB)

(21) Appl. No.: 10/572,966

(22) PCT Filed: Sep. 22, 2004
(86) PCT No.: PCT/GB04/04029

§ 371 Date: Mar. 21, 2006

(30) Foreign Application Priority Data
Sep. 30, 2003 (GB) 0322860.8
Dec. 31, 2003 (GB) 0330265.0

(51) Int. Cl. G06F 17/30

(52) U.S. Cl. 707/9

(57) ABSTRACT

A method and apparatus are provided for use in enabling a user to access online services of a type requiring certain types of personal data to be supplied to respective service providers. An apparatus is provided having a store for storing profile data for use both by users and by service providers to store personal information in respect of those users. The apparatus also has user and service provider interfaces to enable read and write access to the store, identity management means and a profile access controller arranged to implement user-defined access controls in respect of a user's stored profile data. The identity management means are triggerable to allocate or to cease a pseudo-identifier in respect of a user and a selected service provider, the pseudo-identifier being the only identifier by which the service provider may access profile data stored in the store in respect of the user.

This invention relates to personalisation and in particular to a method and apparatus for managing access to personal information in electronic systems.

There has been considerable research effort directed to the problem of maintaining the integrity and security of personal information used in online services, particularly those services deployed over the Internet. This has been motivated by concerns by consumers and representative bodies over the ease with which, service providers and other parties are able to capture personal information relating to those consumers and the potential for misuse of that information.

There are a number of different scenarios that need to be considered. There are those scenarios in which personal information is supplied willingly by the consumer, for example where a consumer supplies certain types of personal information when registering with a provider of online services, whether or not the consumer realises that the service provider is thereby provided with means for consistently identifying the consumer in future transactions. There are also those scenarios in which a consumer may not be aware that their online activities are being monitored and analysed by one or more parties in order to build up a profile of observed interests and preferences for that consumer. If used properly, and with the consumer's implicit or explicit approval, the latter type of information can be particularly useful for both consumer and service provider in personalising the services being accessed and provided. However, while efforts are being made to create standard models for providing online services that take account of the need to handle personal information correctly and securely, desires of consumers for greater control over the release and subsequent use of their personal information are not always consistent with commercially motivated desires of service providers.

It is known to provide a single-logon facility whereby a user's login data is stored securely but is released automatically to predetermined service provider web sites when the user accesses those sites. To some extent, a user is able to specify to whom their personal information is released. This facility may be implemented as a computer program running on the user's personal computer, e.g. the “Roboform” software, accessible over the internet at http://www.roboform.com. or, in the case of Microsoft's .NET Passport, a third-party server stores the user's personal information and supplies it to service provider sites under the control of the user. A secure user interface to the third-party server enables the user to enter personal information for storage and to enter access control information as required. If required, known arrangements such as these can be used to provide a degree of anonymity to users through the use of pseudo-identifiers. However, even a pseudo-identifier can be used by a service provider to build up a profile of personal information about a particular user if that identifier is consistently used, and it is often possible for a pseudo-identifier to be cross-referenced to a user's true identity should the service provider have access to data supplied, perhaps unknowingly by the user, in a completely unrelated transaction in which a “hook” into the user's true identity may have been revealed, e.g. an address. Sharing of information between service providers may also be sufficient to “complete the picture” in respect of a given user.

Referring now to earlier patent documents, International patent application number WO 99/39281 relates to methods by which users may interact with the Internet, and discusses the personalisation of a user's interaction with the Internet, in particular with reference to searching for and retrieval of information from the Internet. In order to allow a person to interact with the Internet in different ways, the person may be provided with one or more “virtual personalities”, each of which may interact with the Internet in a manner dependent on particular static characteristics (“persona”) or dynamic characteristics (“moods”) of the personality. There is a brief discussion relating to security, and of how a user may wish to use his persona to affect his view of the Internet while only wanting to provide portions of the persona and/or mood to each site, in order to limit the amount of information that becomes freely available to each site.

U.S. Pat. No. 6,671,682, which was published after the priority date of the present application, relates to methods and systems for performing tasks on a computer network using user personas. A plurality of user personas, relating to various criteria for performing tasks, are created, and at least one of these is then selected when a searching task is to be performed.

According to preferred embodiments of the present invention there is provided an apparatus for use in accessing online services over a communications network, the apparatus comprising:

a store for storing profile data for use in relation to said online services;

an interface for use by suppliers of online services to enable retrieval from and input to said store of profile data in respect of users;

identity management means; and

a profile access controller arranged to implement user-defined access controls in respect of a user's stored profile data,

wherein said identity management means are triggerable to allocate or to cease a pseudo-identifier in respect of a user and a selected service provider and wherein, in use, said profile access controller restricts access by the selected service provider to stored profile data in respect of said user by means of said pseudo-identifier.

An apparatus according to preferred embodiments of the present invention provides a managed profile server from where service providers may gain access to certain types of personal information relevant to users of their services, enabling such services to be personalised to those users. In use, service providers are strongly encouraged, preferably as a condition of access to a user's stored personal profile data, to store in that same profile data store of the apparatus any personal information that they may capture independently in respect of that user where it can be made visible to the user, so increasing trust between user and service provider.

The apparatus allocates to each service provider a different pseudo-identifier with which to access a particular user's personal profile data. The same allocated pseudo-identifier is used by a service provider to access both information stored by the service provider in respect of the corresponding user and information stored by or on behalf of the user. Being the only identifier for a user, the user's anonymity is preserved, at least with respect to transactions involving the apparatus of the present invention. This enables the apparatus to provide a very effective means for cutting off access by a service provider to a user's stored profile data in that the termination of a pseudo-identifier also renders useless any personal information that might have been gathered independently by the service provider with respect to that user's former pseudo-identifier.

Access by service providers to stored profile data is also strictly controlled through user-defined access permissions. These permissions enable a user to define those types of personal profile data that may be accessed by each specific service provider.

In transactions between users and service providers, the apparatus is used preferably in the role of a proxy, that is, as an intermediary in communications between users and specified service providers. The apparatus is arranged to recognise any data included in such originating communications that might provide a clue to the true identity of a user, e.g. an IP address for the user's terminal equipment connection or information inserted by the user's browser software, and to either remove it or replace it with pseudo-information generated by the apparatus before forwarding the communication to a service provider. Hence, the only user identifier forwarded in transactions with service providers is an identifier allocated by the apparatus itself, so preserving the anonymity of users.

When a user requires to access a service provider for the first time, the apparatus preferably allocates a temporary identifier for the user which is forwarded to the service provider in an access request message. Should it be necessary subsequently for the service provider to gain access to the user's personal information stored with the apparatus, then if the user agrees, the apparatus allocates a pseudo-identifier for the user which is unique to the service provider and which may be used by the service provider to access stored personal information to which the user has granted permission for access. A different pseudo-identifier will be allocated for the user for use by each service provider. Hence, should the user be motivated to arrange for the termination of that pseudo-identifier, for example because of a misuse of the user's personal data, the penalty for the respective service provider is loss of contact with the user's personal profile data and with the user's identity, though without affecting access by other service providers.

Preferably, apparatus according to preferred embodiments of the present invention may be implemented in conjunction with or may be arranged to operate in co-operation with a third party payments system so that users may make indirect payments for goods or services received, further protecting anonymity.

In a preferred embodiment, the profile access controller is operable to recognise at least one predetermined invalid access condition with respect to stored profile data for a user and wherein the identity management means are responsive to said recognition by said profile access controller, and/or to a trigger signal from the user, to render a pseudo-identifier invalid for a respective service provider and hence to disable access by the respective service provider to profile data stored in respect of the user.

In a further preferred embodiment of the present invention, the apparatus further comprises profile data analysis means operable to identify, in stored profile data, information likely to compromise user anonymity and, if appropriate, to generate a warning message. In particular, the profile data analysis means are operable to compare a type of data stored by a service provider in respect of a user with a data type to which the user has granted access permission for that service provider enabling some control over the types of data that a service provider may be allowed to capture and store. The profile data analysis means may also be arranged to detect distinctive characteristics in stored user profile data by comparing data contained in a user's profile with data contained in other user profiles or by comparing data contained in a user's profile with predetermined data characteristics stored in a reference store.

Preferred embodiments of the present invention will now be described in more detail and with reference to the accompanying drawings, of which:

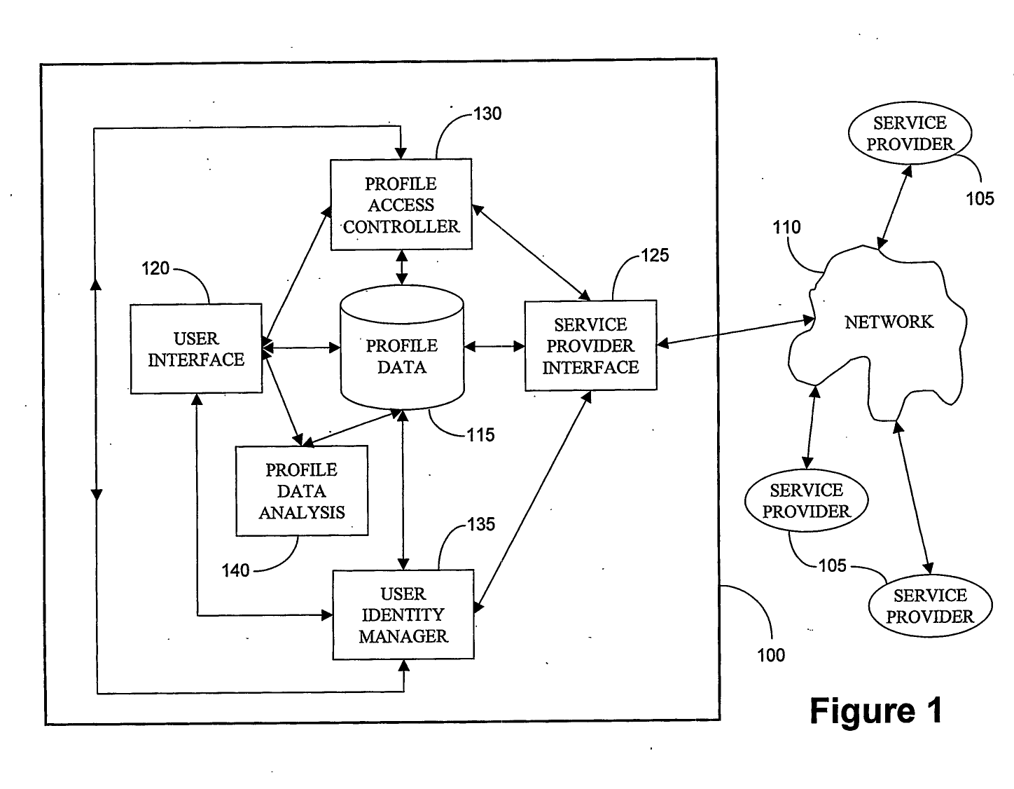

FIG. 1 shows an apparatus according to a preferred embodiment of the present invention;

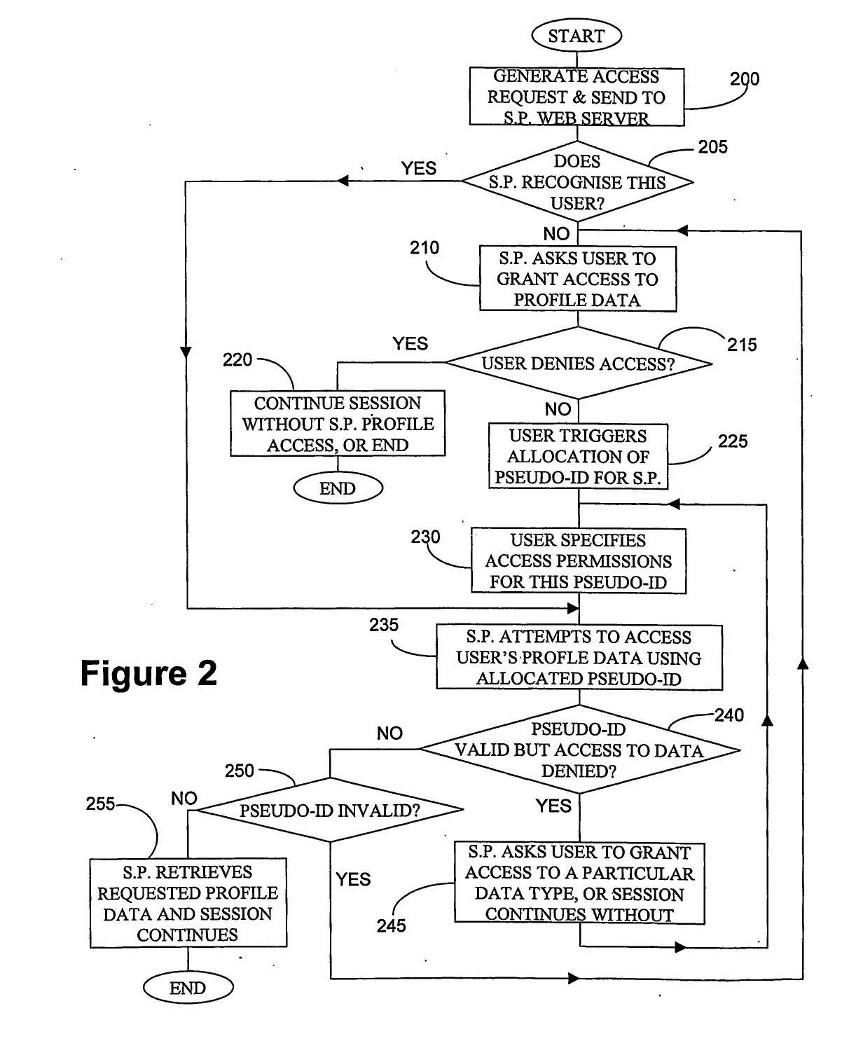

FIG. 2 is a flow chart showing a sequence of steps in a typical end-to-end rocess making use of the apparatus of FIG. 1;

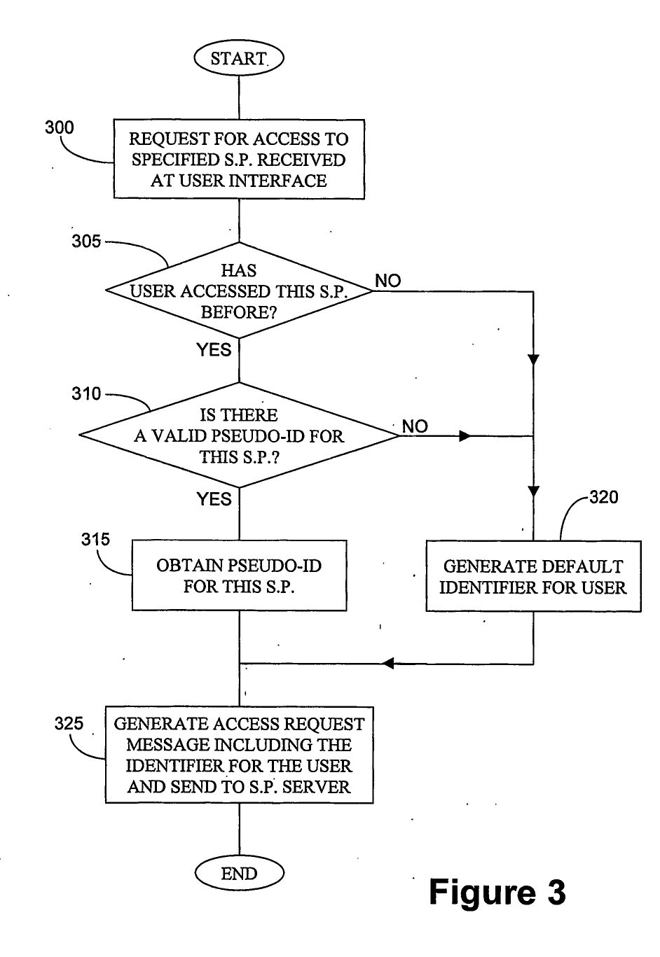

FIG. 3 is a flow chart showing in more detail the steps involved in process step 200 of FIG. 2.

An apparatus according to a preferred embodiment of the present invention will now be described with reference to FIG. 1.

Referring to FIG. 1, a server 100 is provided, accessible to service providers 105 and to users (not shown) by means of a communications network 110, for example the Internet or other public or private network. The server 100 preferably operates in the role of a proxy server in communications between users and service providers, as will be clear from the description below. The server 100 comprises a profile data store 115 for storing personal profile data, both on behalf of users and on behalf of service providers 105 in respect of those users. That is, the profile data store 115 is arranged to store both personal data entered by users and intended for access by selected service providers 105, and personal data gathered independently by service providers 105 in respect of those users. The server 100 also comprises a user interface 120 providing access to the user facilities of the server 100, and a service provider interface 125 providing access to the service provider facilities of the server 100, in particular facilities to enable access to the profile data store 115 in respect of particular users. Both interfaces 120, 125 implement secure communications protocols to prevent unauthorised access to data in transit between the server 100 and users or service providers 105.

In the role of a proxy, the server 100 is arranged, by means of the user interface 120 in particular, to act as an intermediary in communications between a user and a service provider 105. This is to ensure that no information that might be useable to discover the true identify the user, for example through data conveyed in messages originating from a user's terminal equipment, is forwarded to a service provider 105.

A profile access controller 130 is arranged to implement predetermined access controls in respect of data stored in the profile data store 115, in particular by service providers 105. A user identity manager 135 performs allocation and termination of user identifiers, referred to as “pseudo-identifiers” in this patent specification, for use by service providers to gain access to stored profile data. Such pseudo-identifiers are designed to preserve the anonymity of users in transactions with selected service providers 105. A profile data analysis module 140 is also provided to implement a number of algorithms designed to identify particular characteristics in stored user profile data that might compromise ongoing integrity of a user's personal information. These algorithms will be described in more detail below.

In order to more fully describe the function of the various apparatus features defined in FIG. 1, a typical process will now be described with reference to FIG. 2 and to FIG. 1 whereby a user accesses an online service from a service provider 165 over the Internet 110. Roles of the relevant apparatus features of FIG. 1 will be defined at each step in the process. It will be assumed in describing this process that the online service being accessed by a user is one for which access to various items of the user's personal data would be at least preferred by the respective service provider, if not essential to provision of the service.

Referring to FIG. 2, and additionally to FIG. 1, the process begins, and at STEP 200 the online session begins when an access request message is generated by the user interface 120 of server 100 and forwarded on behalf of a user to a specified service provider's server 105. In the Internet context, communication between the server 100 and the service provider's web server 105 is achieved using standard internet protocols and, in particular, the access request message is a hypertext transfer protocol—HTTP—request message, as described for example in “HTTP: The Definitive Guide”, by Brian Totty, David Gourley, Marjorie Saver, Anshu Aggarwal and Sailu Reddy, published by O'Reilly UK, ISBN 1565925092. The steps involved in achieving STEP 200 will be described separately below.

At STEP 205, on receipt of the access request message, the service provider server 105 determines whether or not the user identified in the access request message is known to that service provider 105. If not, then on the assumption that the service provider 105 is likely to require access to personal data stored (115) on the server 100, the service provider 105 responds at STEP 210 to the received access request message with a request for the user to grant access to personal information stored (115) on the server 100. The user interface 120 of server 100 forwards the request to the user. If, at STEP 215, the user refuses the request by the service provider 105, then at STEP 220, either the online session continues without the service provider having access to the user's stored personal information 115, or such access is deemed essential in order for the service provider 105 to continue with the session and the session is terminated.

If, at STEP 215, the user is prepared to grant access to personal information stored on the server 100 then, at STEP 225, the user triggers, via the user interface 120, allocation by the user identity manager 135 of a new pseudo-identifier for use in identifying the user to this particular service provider 105 and by means of which the service provider 105 may gain access, via the service provider interface 125, to stored profile data 115 for that user. The allocated pseudo-identifier is communicated to the service provider 105. In addition to triggering allocation of a pseudo-identifier, the user specifies, at STEP 230, access permissions applicable to this pseudo-identifier for access by the service provider 105 to particular types of personal information stored in the profile data store 115. For example, the user may not wish to grant access by this particular service provider 105 to financial data, but may be prepared to grant access to profile data defining the user's interests.

Having established the means by which the service provider 105 may access the profile data store 115, or having received a recognisable pseudo-identifier in the original access request message at STEP 200, the service provider 105 attempts at STEP 235, to access the profile data store 115 with the pseudo-identifier and an appropriate password, and to extract personal data required in association with the requested service. Three outcomes are considered: (1) that while the pseudo-identifier is valid, the service provider 105 has attempted to extract a type of personal data for which the user did not grant permission, at STEP 230 for example; (2) that the pseudo-identifier is, or for some reason has become, invalid; and (3) that the attempt was successful and the required personal data is successfully retrieved by the service provider 105 from the profile data store 115.

In case (1), as defined by a positive result for the test at STEP 240 in FIG. 2, then at STEP 245, the service provider 105 may either communicate to the server 100 a request for the user to grant permission to access a particular type of personal data, in which case processing returns to STEP 230, or to continue with the session without the requested profile data. Continuation with the session may of course not be possible, in which case the session will necessarily end, as at STEP 220.

In case (2), as defined by a negative result at STEP 240 and a positive result at STEP 250, processing returns to STEP 210, otherwise, in case (3), as defined by a negative result at STEP 255, the service provider 105 successfully retrieves the required personal data for the user from the profile data store 115 and the session continues.

The steps involved in achieving STEP 200 of FIG. 2 will now be described in more detail with reference to FIG. 3, emphasising the proxy role of the server 100 in communications between a user's terminal equipment and a service provider 105.

Referring to FIG. 3, the process begins at STEP 300 with the user transmitting a request via the user interface 120 of server 100 for access to an online service provided by a specified service provider 105. Preferably the user initiates the request by means of an appropriate browser program running on a personal computer and communicating with the server 100 using standard internet protocols over the internet 110. At STEP 305, the user identity manager 135 of server 100 determines whether or not this user has accessed this specific service provider 105 in the past. If the user has accessed this service provider 105 in the past then, at STEP 310, the user identity manager 135 determines whether or not there exists a valid pseudo-identifier for use in identifying the user to this specific service provider 105. If there is, then at STEP 315 the corresponding pseudo-identifier is obtained, otherwise, at STEP 320, a temporary identifier is allocated for the user instead. The temporary identifier cannot be used to access the profile data store 115 but it nevertheless provides some form of identifier for the user which preserves the user's anonymity. At STEP 325, the server 100 generates an access request message incorporating the identifier obtained at STEP 315 or allocated at STEP 320, and sends the message to the service provider 105 specified by the user at STEP 300.

It was mentioned above with reference to FIG. 1 that a profile data analysis module 140 may be provided to carry out certain types of analysis on stored user profile data (115). One reason for including such a feature in the apparatus of FIG. 1 is to ensure that, should a pseudo-identifier be terminated in respect of a particular service provider 105, certain characteristics of the user's stored profile data do not render those data recognisable in future transactions with the same service provider. Even though such transactions would be carried on under a different pseudo-identifier, if the service provider 105 is able to recognise certain characteristics in profile data, it may be able to make an undesirable connection with the same user's earlier transaction history with that service provider.

The profile data analysis module 140 may be arranged to make periodic checks on stored profile data and, on detecting any particularly unusual or recognisable characteristics, issue a warning message for the benefit of a respective user so that appropriate modifications may be made if desired. The profile data analysis module 140 may also be arranged to analyse profile data stored by service providers 105 with respect to users and to detect certain characteristics in those data, for example by comparing the types of data being stored with the types of data to which the user has granted access permissions to ensure that the service provider 105 is not trying to capture such data types by other means. Again, an appropriate warning message may be generated for the benefit of the user should such aspects be detected.

Various known information processing techniques may be applied by the profile data analysis module 140 to detect such unusual or distinctive characteristics in profile data. Such characteristics may be detected with reference to stored profile data for other users, or with reference to a reference store of predetermined data characteristics identified, for example through user feedback.

1. An apparatus for use in accessing online services over a communications network, the apparatus comprising:
a store for storing profile data for use in relation to said online services;
an interface for use by suppliers of online services to enable retrieval from and input to said store of profile data in respect of users;
identity management means; and
a profile access controller arranged to implement user-defined access controls in respect of a user's stored profile data,
wherein said identity management means are triggerable to allocate or to cease a pseudo-identifier in respect of a user and a selected service provider and wherein, in use, said profile access controller restricts access by the selected service provider to stored profile data in respect of said user by means of said pseudo-identifier.

2. An apparatus according to claim 1 further comprising monitoring means arranged with access to messages originating from a user and to recognise a predetermined type of information contained within said messages.

3. An apparatus according to claim 2, further comprising means responsive to a recognition by said monitoring means to replace information of said recognised type in a message originating from a user with pseudo-information generated by said identity management means in respect of said user.

4. An apparatus according to claim 2 or claim 3, operable, on receipt of a request message from a user for access to a specified service provider, to generate an access request message, for sending to said specified service provider, containing an identifier for said user allocated by said identity management means.

5. An apparatus according to claim 4, wherein said allocated identifier for said user is a pseudo-identifier allocated by said identity management means.

6. An apparatus according to claim 1, further comprising a user interface operable to enable a user to update respective profile data stored in said store and to define said access controls for implementation by said profile access controller.

7. An apparatus according to claim 1 wherein said profile access controller is operable to recognise at least one predetermined invalid access condition with respect to stored profile data for a user and wherein the identity management means are responsive to said recognition by said profile access controller, and/or to a trigger signal from the user, to render a pseudo-identifier invalid for a respective service provider and hence to disable access by the respective service provider to profile data stored in respect of the user.

8. An apparatus according to claim 1, for use in the role of a proxy server disposed between a user and a service provider.

9. An apparatus according to claim 1, further comprising:
profile data analysis means operable to identify, in stored profile data, information likely to compromise user anonymity.

10. An apparatus according to claim 9, wherein the profile data analysis means are operable, on identifying information likely to compromise user anonymity, to generate a warning message.

11. An apparatus according to claim 9, wherein the profile data analysis means are operable to compare a type of data stored by a service provider in respect of a user with a data type to which the user has granted access permission for that service provider.

12. An apparatus according to claim 9, wherein the profile data analysis means are operable to detect distinctive characteristics in stored user profile data.

13. An apparatus according to claim 12, wherein the profile data analysis means are operable to detect said distinctive characteristics by comparing data contained in a user's profile with data contained in other user profiles.

14. An apparatus according to claim 12, wherein the profile data analysis means are operable to detect said distinctive characteristics by comparing data contained in a user's profile with predetermined data characteristics stored in a reference store.

15. An apparatus according to claim 1, wherein said identity management means is arranged to allocate a different pseudo-identifier in respect of a user in respect of each of a plurality of different service providers.

16. (canceled)
